(19) United States
(12) Patent Application Publication
(10) Pub. No.: US 2007/0084625 A1
(43) Pub. Date: Apr. 19, 2007

(54) System and method for managing cables in a display stand

(76) Inventors: Randall W. Martin, The Woodlands, TX (US); Paul L. Drew, The Woodlands, TX (US); Nick Woodley, London (GB); David Quijano, Magnolia, TX (US); Stephen de Saulles, London (GB); Morten Warren, London (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,438

(22) Filed: Oct. 17, 2005

(51) Int. Cl. H01B 7/00

(52) U.S. Cl. 174/135

(57) ABSTRACT

Embodiments of the present technique relate to a system and method for managing cables in a display stand. Specific embodiments of the present technique include a display stand having a cable passage between a pliable flap and a vertical structural member, the cable passage traversing a portion of the vertical structural member, and a display coupled to the display stand.

### BACKGROUND

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Home entertainment systems, personal computers, and the like generally include displays that receive power and communicate with other devices via cables. These displays are often implemented with other components, and peripheral devices that generally occupy the same workspace or area. For example, a flat panel computer display is often utilized along with optional accessories such as speakers and cameras that are mounted to the flat panel display. The peripheral devices, other components, and the display itself often utilize various combinations of cables (e.g., signal cables and power cables) to operate and communicate with one another.

Unfortunately, it can be cumbersome to have a number of cables from various devices and peripherals in the same area. Indeed, the various cables can become tangled and disorganized, resulting in an unaesthetic appearance and logistical issues relating to connecting and disconnecting the cables. For example, devices can become dislodged or disconnected due to cables being snagged or pulled inadvertently.

### BRIEF DESCRIPTION OF THE DRAWINGS

Advantages of one or more disclosed embodiments may become apparent upon reading the following detailed description and upon reference to the drawings in which:

FIG. 1 is a perspective view of a computer system with various peripheral components disposed about a display, the computer system having cables that pass through a cable routing system of a display stand in accordance with embodiments of the present technique;

FIG. 2 is a cross-sectional view of multiple flexible lips of the cable routing system, the multiple flexible lips being stacked atop one another to provide layers of cable passages in accordance with embodiments of the present technique;

FIG. 3 is a cross-sectional view of the flexible lip adjacent the display base, the flexible lip having a rigid portion and a flexible portion that operates as a biased hinge in accordance with embodiments of the present technique;

FIG. 4 is a perspective view of the display stand and the cable routing system coupled to a display base, wherein the cable routing system includes a pliable flap of the display stand and a vertical structural portion of the display stand in accordance with embodiments of the present technique;

FIG. 5 is a perspective view of the display stand and the cable routing system coupled to a display base with a cable disposed within the cable routing system, wherein the cable routing system is formed by the pliable flap of the display stand and the vertical structural portion of the display stand in accordance with embodiments of the present technique;

FIG. 6 is a perspective view of the display stand and the cable routing system coupled to the display base, wherein the cable routing system includes multiple cable channels that receive the cables via access flaps and route the cables along the cable passage of the cable routing system to different locations on the display stand in accordance with embodiments of the present technique;

FIG. 7 is a perspective view of the display stand and the cable routing system coupled to the display base, wherein the cable routing system includes multiple cable channels that include adjacent flexible flaps or pliable lips disposed on a back portion of the display stand in accordance with embodiments of the present technique;

FIG. 8 is a cross-sectional view of the flexible lip adjacent the display stand, the flexible lip having a U-shaped recess that defines a cable channel for routing the cables in accordance with embodiments of the present technique;

FIG. 9 is a cross-sectional view of the flexible lip adjacent the display stand, the display stand having a U-shaped recess adjacent the flexible lip to define a cable channel for routing the cables in accordance with embodiments of the present technique;

FIG. 10 is a cross-sectional view of the flexible lip adjacent the display stand, the display stand having an L-shaped recess adjacent the flexible lip to define a cable channel for routing the cables, and the flexible lip having a centralized access opening in accordance with embodiments of the present technique;

FIG. 11 is a cross-sectional view of the flexible lip adjacent the display stand, the flexible lip and display stand defining a cavity that operates as a cable passage in accordance with embodiments of the present technique;

FIG. 12 is a perspective view of the rear of the display stand and the cable routing system, wherein an exit portal cover is being disposed over an exit portal in the cable routing system in accordance with embodiments of the present technique;

FIG. 13 is a perspective view of the rear of the display stand and the cable routing system, wherein a connector block is utilized to consolidate cables disposed within the cable routing system in accordance with embodiments of the present technique; and

FIG. 14 is a plan view of the cable routing system separate or disconnected from the display stand in accordance with embodiments of the present technique.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions will be made to achieve the developers' specific goals, such as compliance with system-related and business-related constraints, which can vary from one implementation to another. Moreover, it should be appreciated that such a development effort can be complex and time consuming, but would remain a routine undertaking of design, fabrication, and manufacture for those of ordinary skill having the benefit of this disclosure. It should be noted that illustrated embodiments of the present invention throughout this text represent a general case.

Embodiments of the present technique generally relate to efficiently and aesthetically managing cables in a limited workspace. Specifically, embodiments of the present technique relate to a cable routing system for a display stand, which may be defined as a supporting part of a display (e.g., monitor, video screen, all-in-one computer, panel computer, liquid crystal display or television, plasma display or television, or conventional television) that projects upward from a base or foundation of the display. Such a routing system facilitates flexible organization, retention, and concealment of cables for peripheral components disposed about and/or on a display, such as cables (e.g., power and video cables) extending from the display itself, by employing flexible material to receive, conceal, and hold the cables. In one embodiment, the flexible, material can accommodate a variety of sizes and quantities of cables due to the flexible nature of the material. In addition, the flexible material enables removable retention of the cables without using tools or threaded fasteners. Accordingly, a user can mount the cables by simply sliding or pushing the cables under the flexible material. As discussed in detail below, the disclosed routing system includes a length of flexible or pliable material (e.g., a pliable flap) disposed over the cables along a cable passage or route, such that the cables can be easily retained or removed from within the display stand along an edge or through an opening in the pliable material.

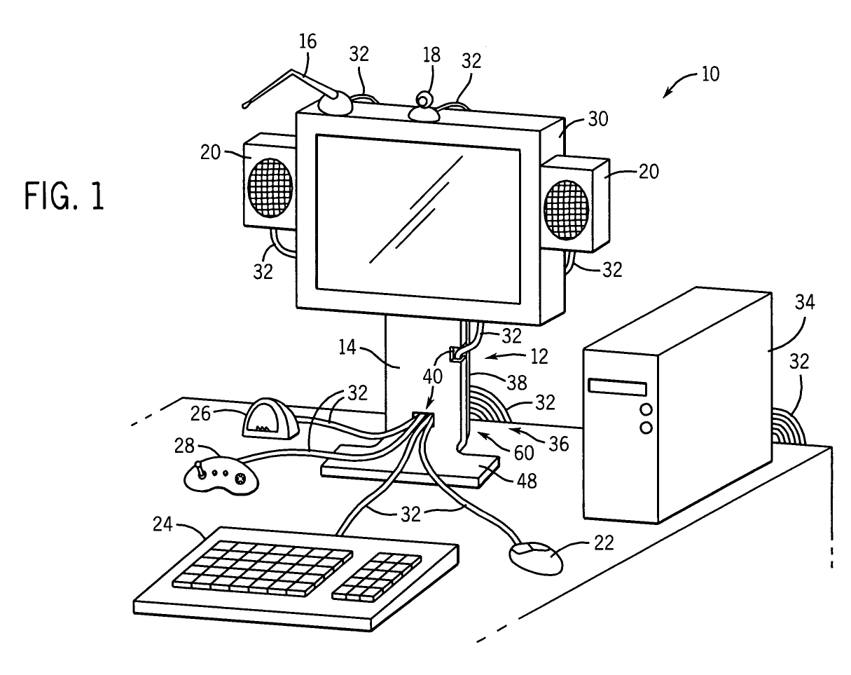

FIG. 1 is a perspective view of a computer system 10 having a cable routing system 12 on a display stand 14 in accordance with certain embodiments. Specifically, FIG. 1 depicts the computer system 10 with various peripheral components 16, 18, 20, 22, 24, 26, 28 disposed about the display stand 14 and a corresponding display 30. The various peripherals 16, 18, 20, 22, 24, 26, 28 and the display 30 have cables 32 that pass through the cable routing system 12 on the display stand 14. These cables 32 include power and/or a communication cables. It should be noted that in some embodiments, the cables 32 include those from devices only tangentially related to the computer system 10, such as cables that extend from other devices near the display 30. For example, the cables 32 can include cables from an alarm clock, electric pencil sharpener, or electric stapler disposed in or near the workspace surrounding the computer system 10.

The cable routing system 12 flexibly organizes, retains, and conceals all or a portion of the cables 32 from view as they are routed along the display stand 14 for connection to a computer 34, to other peripheral components, and/or to the display 30. In the illustrated embodiment, the cables 32 from the peripheral components 16, 18, 20, 22, 24, 26, 28 couple to the display stand 14 via the cable routing system 12 and are accumulated near a bottom rear portion 36 of the display stand 14. This facilitates connection of the massed cables 32 to the computer 34. It should be noted that in some embodiments, the cables 32 are massed at an exit portal in the cable routing system 12, thus organizing the cables 32 into a group, facilitating efficient use of space, and improving aesthetic appeal. In some embodiments, this exit portal is located at the bottom rear portion 36 of the display stand 14. Further, in some embodiments, a connector block is included that communicatively couples to one or multiple of the peripheral components (e.g., 16, 18, 20, 22, 24, 26, 28) and/or the display 30. Such connector blocks can provide a single point of access via an umbilical cable (e.g., a cable adapted to transmit power and/or communication signals to and from a number of devices). Additionally, it should be noted that the connector block can be integral or separate from the cable routing system 12.

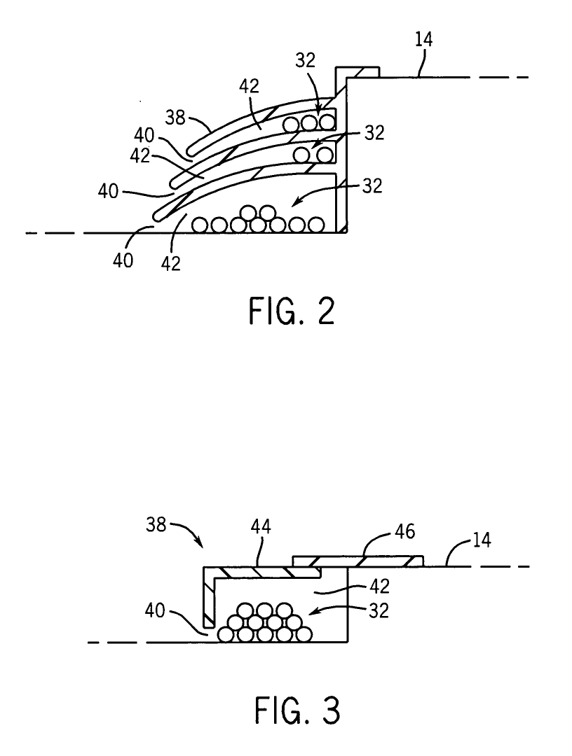

The cables 32 are routed underneath a strip of flexible material, a pliable flap, or flexible lip 38 of the cable routing system 12. In some embodiments, cables 32 for certain devices (e.g., 22, 24, 28) enter the routing system 12 via a portal or opening 40 (e.g., an opening or slit) in the display stand 14. The flexible lip 38 extends outward from a connection point on the display stand 14 and defines a cable passage 42 along the periphery of the display stand 14. In some embodiments, the cable passage extends along different portions (e.g., along the middle) of the display stand 14. For example, in one embodiment, the flexible lip 38 covers a large cavity formed in a central portion of the display stand 14, thus providing storage and concealment for a large number of cables 32. Further, in some embodiments, multiple flexible lips 38 are employed. For example, FIG. 2 is a cross-sectional view that illustrates multiple flexible lips 38 stacked atop one another to provide layers of cable passages 42. Having multiple layers of cable passages 42 enables a user to organize cables 32 according to layer. Moreover, the extra layers provide routing and concealment for additional cables 32.

As illustrated in FIG. 1, the flexible lip 38 extends lengthwise along the periphery of the display stand 14, defining a portion of the cable routing system 12. Access to the cable routing system 12 is provided by a slit, groove, or general opening 40 that enables insertion and removal of the cables 32. For example, FIG. 1 illustrates both an opening 40 in a font portion of the display stand 14 and an opening 40 on a side of the display stand 14 near the flexible lip 38.

In one embodiment, the flexible lip 38 includes a single piece or strip of flexible material (e.g., rubber or plastic) secured to the display stand 14 via an adhesive, screws, latches, or other fasteners. In another embodiment, as illustrated by FIG. 3, the flexible lip 38 includes a rigid portion 44 and a flexible portion 46 that operates as a biased hinge. The rigid portion 44 lifts up to receive the cables 32 and then the flexible portion 46 causes it to flex back into place, thus retaining the cables 32 in position. The flexible lip 38 is biased against the display base 14 or another flexible lip 38 such that when the cable 32 is routed underneath the flexible lip 38, the cable 32 is retained (e.g., pressed against the display base 14) and at least partially concealed by the flexible lip 38. In one embodiment, the flexible lip 38 is adapted to retain the cable in a chamber separate from the flexible lip 38.

The peripheral components illustrated in FIG. 1 include a microphone 16, a camera 18, speakers 20, a mouse 22, a keyboard 24, a personal digital assistant (PDA) recharging/linking cradle 26, and a game controller 28. These are exemplary peripheral components, and it should be noted that different peripheral components can be incorporated in other embodiments. Also, while in the illustrated embodiment the display 30 is a flat panel computer monitor, in other embodiments, the display 30 can include a television, a cathode ray tube (CRT), a laptop display, an all-in-one computer, a panel computer, and so forth. For example, the all-in-one computer generally includes the display 30 and computer (e.g., processor, motherboard, memory, disc drive, video card, and audio card) all in a single enclosure. By further example, the panel computer includes a flat-panel display 30 and computer disposed in a single panel-shaped housing.

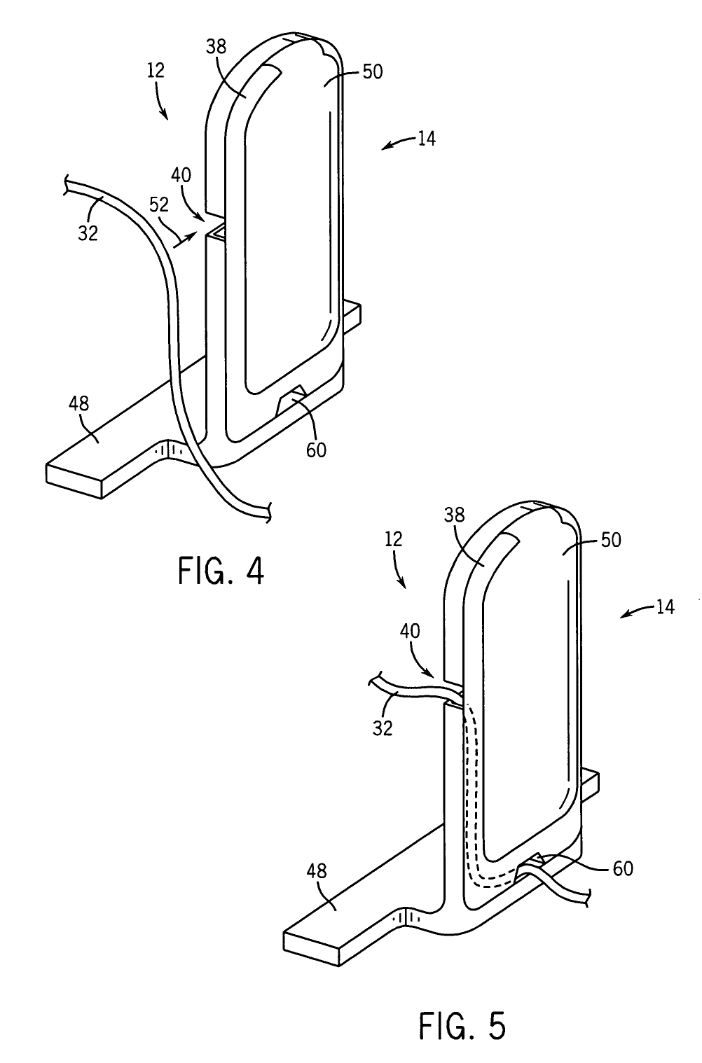

FIGS. 4 and 5 are perspective views of the display stand 14 coupled to a display base 48. In the embodiment illustrated by FIGS. 4 and 5, the cable routing system 12 includes two adjacent portions of the display stand 14—the pliable flap 38 rigid column 50. The rigid column 50 can include any vertical structural member utilized in the display stand 14. The display stand 14 facilitates coupling of the display base 48 to the display 30, as illustrated in FIG. 1. Specifically, in FIG. 4, the cable 32 is being disposed within the cable routing system 12, as illustrated by arrow 52. For example, the arrow 52 represents maneuvering a portion of the cable 32 into the opening 40 and then wedging it between the pliable flap 38 and the rigid column 50 along the perimeter of the display stand 14. The result is represented in FIG. 5, which illustrates the cable 32 disposed within the cable routing system 12.

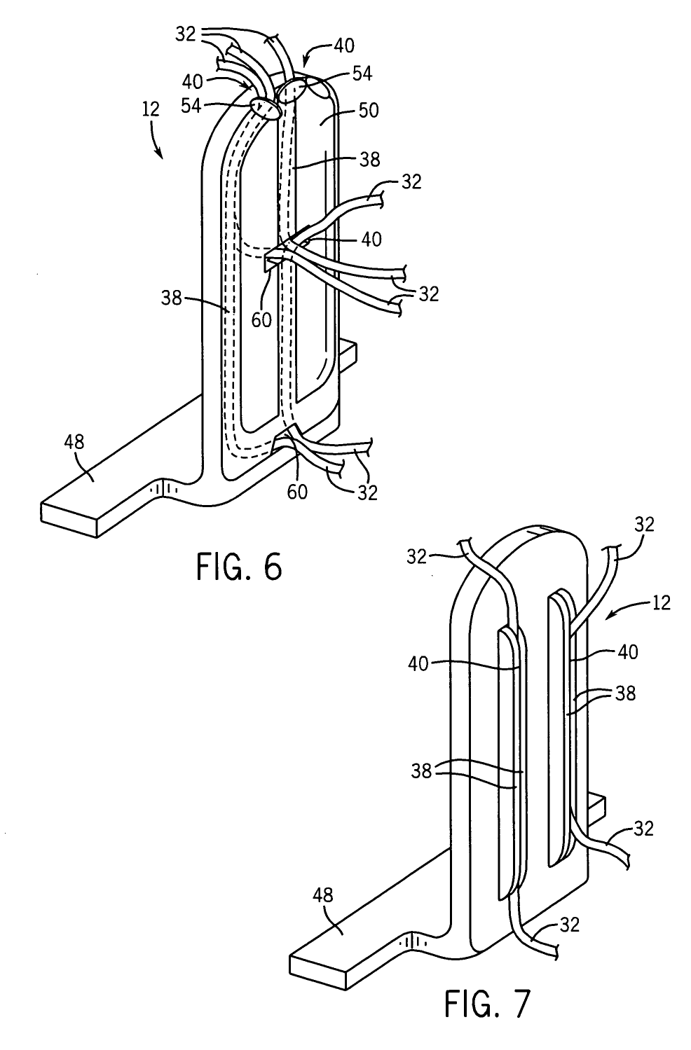

In some embodiments, the display stand 14 provides cable access at different points. For example, FIG. 6 illustrates different locations for openings 40, which facilitate storing and removing the cables 32 from the cable routing system 12. Specifically, FIG. 6 illustrates openings 40 disposed on the top and in an upper central portion of the display stand 14 to facilitate access to the cables 32 disposed within the stand at an upper portion of the stand 14. Additionally, in the embodiment illustrated by FIG. 6, the openings 40 at the top of the display stand 14 face upward and are accessible by opening access flaps 54 in the pliable flap 38. Further, while the cable routing system 12 illustrated by FIGS. 4 and 5 is disposed substantially along a perimeter of the display stand 14, in other embodiments, the cable routing system 12 is disposed on different portions of the display stand 14. For example, FIG. 6 illustrates the cable routing system 12 disposed along the top of the display stand 14 and along the perimeter.

In FIGS. 4, 5, and 6, the pliable flap 38 includes a layer of flexible material that overlays a groove in the rigid material of the column 48 to define the cable passage 42. Other embodiments have different configurations wherein two different adjacent portions of the stand 14 form the cable routing system 12. In some embodiments, the passage 42 is formed by two pliable flaps 38 positioned adjacent one another along a length of the display stand 14. For example, in the embodiment illustrated by FIG. 7, the two adjacent portions are pliable flaps 38 aligned lengthwise vertically along the display stand 14 and the opening 40 is formed by a gap between the pliable flaps 38.

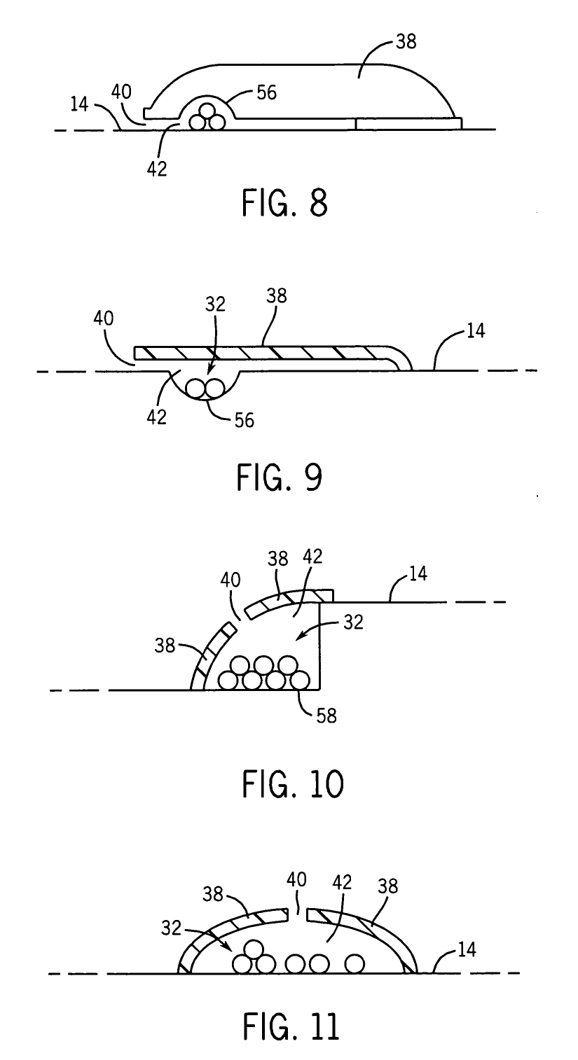

Regardless of whether the cable passage or channel 42 is formed by two adjacent pliable flaps 38, a single pliable flap 38 and the rigid column 50, or a single pliable flap 38 groove in the column 50, the cable channel 42 facilitates retention and concealment of the cables 32 and provides a guide for routing the cables 32. In some embodiments, a groove is disposed in the flexible lip 38, in a panel (e.g., the rigid column 50) adjacent the flexible lip 38, or in both the flexible lip 38 and the panel of the display stand 14. For example, in the embodiment illustrated by FIG. 8, the cable channel 42 includes a U-shaped recess 56 in the flexible lip 38. In another embodiment, the cable channel 42 includes a U-shaped recess 56 in a panel of the display stand 14 adjacent the flexible lip 38, as illustrated in FIG. 9. In yet another embodiment, the cable channel 42 includes an L-shaped portion 58 of a panel of the display stand 14 adjacent the flexible lip 38, as illustrated by FIG. 10. Further, the cable channel 42 can include a cavity or passage between a surface (flat or recessed) of the display stand 14 or cable routing system 12 and the flexible lip 38, as illustrated in FIG. 11. It should be noted that FIGS. 10 and 11 also illustrate a central placement of the opening 40 in the flexible lip 38.

In the embodiments illustrated by FIGS. 1, 4, 5, and 6, the cables 32 are routed along the perimeter of the cable routing system 12, down a central portion of the display stand 14, or directly through the display stand 14 to an exit portal 60 near the back of the display base 14. In the embodiment illustrated by FIG. 6, the display stand 14 includes two exit portals 60—one at the base and one near the top. The exit portal 60 is another opening 40 that facilitates connection of the various peripheral devices 16, 18, 20, 22, 24, 26, the display 30, and so forth to other equipment. Additionally, the exit portal 60 facilitates arrangement of the cables 32 within the cable routing system 12. In some embodiments, the cable routing system 12 is designed such that the cables 32 can enter the cable routing system 12 at a number of locations along the perimeter of the cable routing system 12 via the opening 40. Once the cables 32 are gathered, the cables 32 can then uniformly exit the cable routing system 12 at the exit portal 60 for connection to other components (e.g., computer 34).

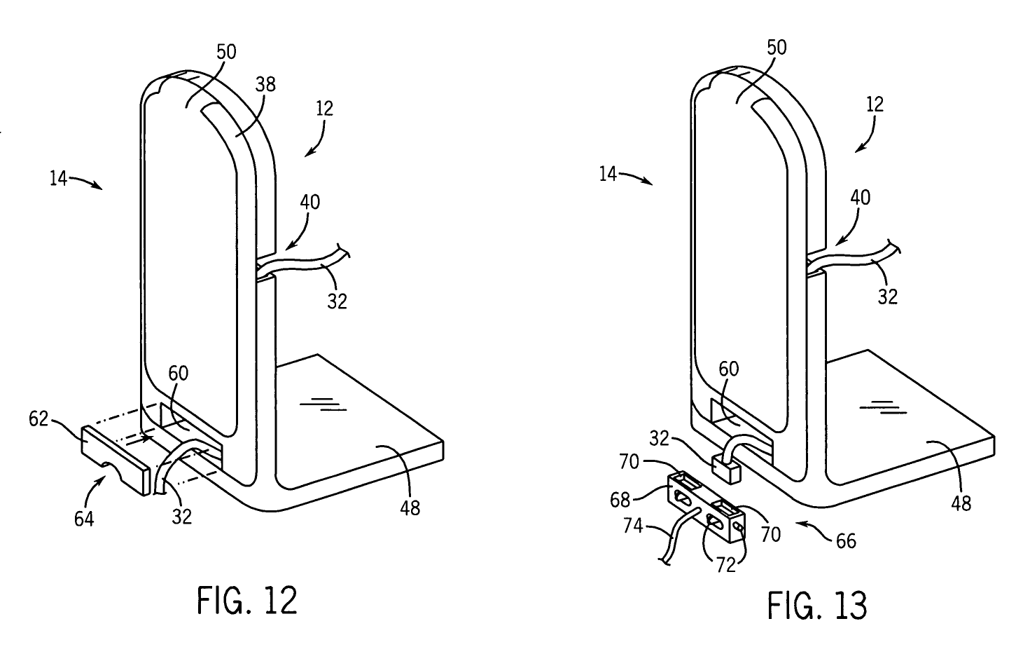

In some embodiments, to improve aesthetic appeal of the display stand 14 and to further organize and retain the cables 32, an exit portal cover 62 is provided, as illustrated in FIG. 12. Specifically, FIG. 12 depicts the exit portal cover 62 being disposed over the exit portal 60, to provide additional concealment, support, and securement for the cables 32. When this exit portal cover 62 is removed, ready access is provided to the cables 32 stored in the cable routing system 12. Having this accessibility facilitates insertion, extraction, and manipulation of the cables 32 in the cable routing system 12 via the exit portal 60. When the exit portal cover 62 is in place over and affixed proximate the exit portal 60, the cables 32 are contained and at least partially concealed from view. The exit portal cover 62 includes a slot 64 that provides a discreet (e.g., smaller) access point for the cables 32, thus improving aesthetic appeal, conserving workspace, and improving organization of the cables 32.

FIG. 13 is a perspective view of yet another embodiment of the present technique, wherein a connector block 66 is utilized to consolidate cables 32 and improve organization. Specifically, FIG. 13 depicts the display stand 14 having the cable routing system 12 with the exit portal 60 being coupled with the connector block 66 at the exit portal 60. The connector block 66 is adapted or configured to couple to the cable routing system 12 and the cables 32. Specifically, the connector block 66 is adapted or configured to communicatively couple to one or multiple of the cables 32 disposed within the cable routing system 12. Thus, the connector block 66 provides a single point of access to the multiple cables 32 and their corresponding components (e.g., peripheral devices 16, 18, 20, 22, 24, 26, 28 and display 30). In the illustrated embodiment, the connector block 66 comprises a main body 68, a plurality of reception ports 70 for coupling to the various cables 32, a tool-free quick connect/release mechanism 72 for attaching and detaching from the cable routing system 12, and a single umbilical cable 74 that consolidates the attached cables 32. The umbilical cable 74 facilitates communicative connection to a device (e.g., computer 34 and/or a power source) and transmission of information and/or power between the device and the cables 32 via the reception ports 70. Additionally, the umbilical cable 74 acts as an extension cord, providing additional length for coupling the cables 32 to other components.

It should be noted that in some embodiments, the tool-free quick connect/release mechanism 72 of the connector block 66 is replaced or supplemented by other connection mechanisms. For example, in some embodiments, latches, screws, male and female components, and so forth can be utilized in place of or in support of the tool-free quick connect/release mechanism 72. Further, it should be noted that while in the illustrated embodiment, the connector block 66 is separate from the cable routing system 12, in other embodiments it is an integral part. In some embodiments, the connector block 66 is integral to the cable routing system 12.

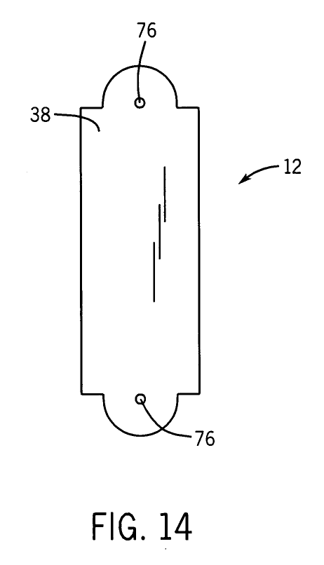

FIG. 14 is a plan view of the cable routing system 12 separate or disconnected from the display stand 14, illustrating one embodiment of the present technique. The cable routing system 12 is adapted to attach to the display stand 14 and to detach therefrom. For example, in the illustrated embodiment, the cable routing system 12 includes attachment points 76 that can be used with screws to couple to the display stand 14. In other embodiments, latches, spring-loaded pins, male and female connectors, adhesives, tape and so forth can be utilized to couple the cable routing system 12 to the display stand 14. For example, in one embodiment the cable routing system 12 has a tacky side that allows for removable coupling to the display stand 14 by pressing the tacky side against the display stand 14. The cable routing system 12 can couple to the front or back portion of a standard display stand. Further, in some embodiments, the cable routing system can couple to side portions of a standard display stand.

Providing the cable routing system 12 separate from the display stand 14 facilitates transfer of the cable routing system 12 between multiple display stands 14. Further, by facilitating detachment and reattachment of the cable routing system 12 with the display stands 14, a user can dispose cables 32 within the cable routing system 12 prior to connecting the cable routing system to the display stand 14 and the display 30. In some embodiments, this improves efficiency and ease of use.

While the present technique may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1-13. (canceled)

14. A cable management apparatus, comprising:
a display stand adapted to couple to and support a display, the display stand comprising:
a structural member; and
a pliable flap extending at least partially across and vertically along a cable route on the structural member.

15. The apparatus of claim 14, wherein the cable route comprises a channel recessed into the structural member.

16. The apparatus of claim 14, wherein the pliable flap and the cable route are disposed along a perimeter of the display stand.

17. The apparatus of claim 14, wherein the pliable flap is removably coupled to the display stand adjacent the structural member.

18. The apparatus of claim 14, wherein the cable route comprises a channel recessed into the pliable flap.

19-23. (canceled)
